(19) United States
(12) Patent Application Publication
(10) Pub. No.: US 2024/0020534 A1
(43) Pub. Date: Jan. 18, 2024

(54) MODEL DISTILLATION FOR REDUCING ITERATIONS OF NON-AUTOREGRESSIVE DECODERS

(71) Applicant: THE TORONTO-DOMINION BANK, TORONTO (CA)

(72) Inventors: Juan Felipe Perez Vallejo, TORONTO (CA); Maksims Volkovs, TORONTO (CA); Sajad Norouzi, TORONTO (CA); Rasa Hosseinzadeh, TORONTO (CA)

(21) Appl. No.: 18/206,395

(22) Filed: Jun. 6, 2023

Related U.S. Application Data
(60) Provisional application No. 63/389,724, filed on Jul. 15, 2022.

(51) Int. Cl. G06N 3/08; G06N 3/0455

(52) U.S. Cl. CPC G06N 3/08; G06N 3/0455

(57) ABSTRACT

A non-autoregressive transformer model is improved to maintain output quality while reducing a number of iterative applications of the model by training parameters of a student model based on a teacher model. The teacher model is applied several iterations to a masked output and a student model is applied one iteration, such that the respective output token predictions for the masked positions can be compared and a loss propagated to the student. The loss may be based on token distributions rather than the specific output tokens alone, and may additionally consider hidden state losses. The teacher model may also be updated for use in further training based on the updated model, for example, by updating its parameters as a moving average.

### CROSS-REFERENCE TO RELATED APPLICATIONS

This application claims the benefit of provisional U.S. application No. 63/389,724, filed Jul. 15, 2022, the contents of which is incorporated herein by reference in its entirety.

### BACKGROUND

This disclosure relates generally to decoder model training, and more particularly to improving training of iterative non-autoregressive decoders.

In autoregressive translation models, a sequence of input tokens is converted with an encoder to an input encoding sequence representing the sequence of input tokens and, using the input encoding sequence, output tokens are generated one at a time by applying the decoder to the input encoding sequence and the current output token sequence. As such, generation of subsequent output tokens may benefit from the previously generated tokens in the output sequence. In addition, these autoregressive models may be able to directly generate formatting tokens, such as a token indicating an end of the token sequence.

One alternate approach is a “non-autoregressive” model architecture (that may also be referred to as a Non-Autoregressive Transformer (“NAT”)), in which a decoder may be applied in parallel to predict several output tokens at the same time. Individual positions in the output token sequence may be characterized by a positional encoding, enabling the output decoder to distinguish different output tokens for different portions of the output sequence. However, this approach, while typically enabling parallelization of output token decoding, can be less accurate and result in repeated output tokens (e.g., repeated words) and other challenges as output tokens in a given application of the decoder do not account for decoding of the surrounding output tokens.

As one way to address this potential error, non-autoregressive models may be applied iteratively, such that each iteration determines a portion of the output sequence that then informs further iterations. For example, the decoder may initially receive an output sequence in which all output tokens are set to a mask token, such that the decoder is applied to each position in the output sequence to generate output token predictions, in parallel, for all positions. The positions having the highest-scoring tokens may be set to the respective highest-scoring tokens, and the decoder is applied again to predict the remaining masked tokens based on the intermediate output token sequence in which two output tokens are set to the tokens determined from the first iteration. Repeated application of the decoder may then reduce the number of tokens to be predicted and increase the portion of the output sentence having non-mask tokens that inform a current iteration. While this approach permits effective parallel translation with non-autoregressive decoding and significantly improves the resulting output, such iterative application of this type of decoder may cause the NAT decoder to lose its time-related advantages relative to sequential autoregressive translation. In many instances, NAT decoders may be configured to apply four, eight, sixteen, or more decoding iterations, depending on the architecture (and output token sequence length), increasing computation and creating time dependencies across iterations of the decoder as only a portion of the output sequence is set to output tokens at each iteration.

### SUMMARY

To reduce the number of iterations for the decoder model, a decoder model that effectively translates outputs in multiple iterations is used as a “teacher” for a “student” model to learn to model in fewer iterations. As such, a teacher model and a student model may share the same architecture, and the student may learn parameter updates to its parameters to better model, in one iteration, what was more than one iteration of the teacher model. The teacher model and student model may be initialized to parameters of a pre-trained iterative non-autoregressive transformer. To train the student model, the teacher model and student model are both applied to the same input token sequence and a masked output token sequence. The teacher model is applied for multiple iterations (e.g., 2, 3, or 4, or more times) to generate the teacher's predicted output tokens, while the student model is applied for fewer iterations than the teacher (e.g., 1 or 2) to generate the student's predicted output tokens. A loss function is determined based on the difference between the teacher and student predictions and used to update parameters of the student model.

In some embodiments, the output token scores (e.g., probabilities) are used to determine the loss function, such that the student model may learn from the relative likelihoods of other output tokens, including e.g., other output tokens that are similar to but not the highest-scoring output token. In addition or as an alternative, the output values for the teacher model may be determined from the respective iterations of the teacher model at which output tokens were determined. For example, the teacher model may select two output tokens in a first iteration and two output tokens in a second iteration (in which the output tokens of the first iteration may be considered fixed), such that the output token scores for determining the loss function with respect to the student model are based on the first iteration for the two output tokens selected in the first iteration and based on the second iteration for the two output tokens selected in the second iteration. In addition or as an alternative, the loss function may also consider a hidden state loss based on the hidden states for the selected models, enabling further knowledge transfer between the teacher model and the student model.

After updating the student model, the student model may be better able to generate similar results to the teacher model in fewer iterations. To further improve the student model (e.g., after convergence of the student model for a given teacher model), the applied teacher model may be modified to train further improvements to the student. That is, the teacher-student distillation process may be iteratively applied to improve the student model. First, the number of iterations that the teacher model is applied may be increased, such that the student model further learns to model an increasing number of iterations of the teacher model. Second, the teacher model may be replaced with the student model, such that the next student model learns to model multiple iterations of the prior student model. Finally, rather than replacing the teacher model, the teacher model may be updated by incorporating the parameter updates as a moving average, such that the teach model parameters are set to the prior teacher model parameters modified by the student model parameters, e.g., as an exponential moving average. This may permit the “teacher” to continue to learn parameters that reduces the number of iterations required for effective decoding, and thus provide an improved “baseline” from which the student model is taught. After training, the student model may then be used for decoding with reduced iterations, reducing the total processing time while maintaining a high level of accuracy for iteratively-applied non-autoregressive models.

### BRIEF DESCRIPTION OF THE DRAWINGS

FIG. 1 shows a translation system that includes a transformer model, according to one or more embodiments.

FIG. 2 shows an example architecture of a transformer model, according to one or more embodiments.

FIG. 3 shows an example of an iterative application of a decoder, according to one or more embodiments.

FIG. 4 shows an example of training data flow for reducing decoder iterations, according to one or more embodiments.

FIG. 5 shows an example data flow for teacher-student distillation of iterative decoding, according to one or more embodiments.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

Architecture Overview

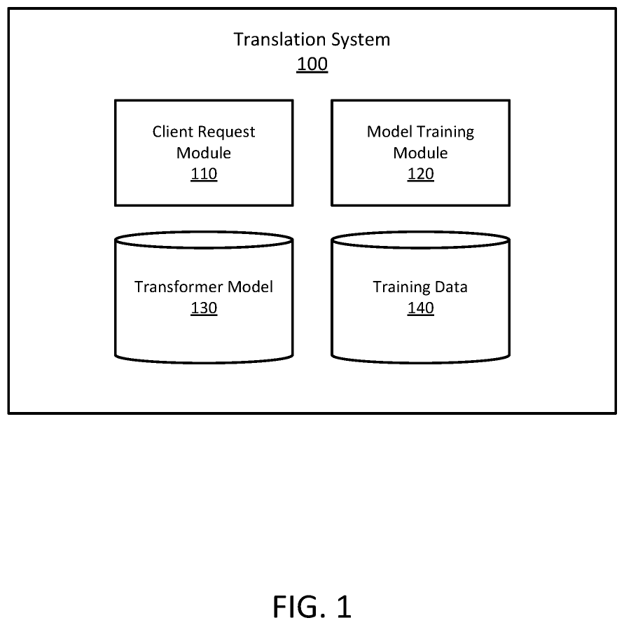

FIG. 1 shows a translation system that includes a transformer model 130, according to one or more embodiments. The transformer model 130 is a trained computer model that learns parameters for converting a sequence of input tokens to a sequence of output tokens. In particular, the translation system 100 trains the transformer model 130 to learn parameters for improved parallel output token prediction (e.g., with a non-autoregressive decoder) with fewer iterative applications of a decoder model. To do so, a transformer model 130 may initially be trained for application of a plurality of iterations of a non-autoregressive decoder. This model may then be further refined with teacher-student distillation, such that a student model learns parameters to output the same (or substantially the same) output tokens in fewer iterations. For example, the student model may be taught to learn parameters for generating similar results in one iteration as was generated by the teacher model in two iterations. The various components of the transformer model 130 and its training are further discussed below. The transformer model 130 may also be referred to as an “autoencoder” and includes an encoder and a decoder portion, each of which may include learnable/trainable parameters.

The sequence of input tokens may also be referred to as an input token sequence or “input tokens” (when referring to the particular sequence of tokens input to the transformer model) for convenience; similarly, the sequence of output tokens may also be referred to as an output token sequence or “output tokens” (when referring to the particular sequence of tokens output by the transformer model). In some embodiments, the sequence of input tokens may belong to a first domain and the sequence of output tokens may belong to a second domain. As one example application, the transformer model 130 may be used to translate text from one language to another. For example, the first domain may be the German language and the second domain may be the English language.

A set on input tokens for the German language may be “wir arbeiten an NLP” and the corresponding output tokens in English may be “we work on NLP.” Each of the input and output tokens may thus represent particular content from the respective domain, such as each of the individual words “we,” “work,” “on,” and “NLP.”

For language translation, the tokens are typically individual words in the respective languages, although in various domains and applications, the tokens in language translation may include other information for the respective domain, such as grammatical marks, accent marks, punctuation marks, and so forth that may be used to accurately represent information in that domain. Each domain may describe, for example, the set of possible tokens (e.g., eligible or candidate tokens) that may be selected from in that domain for generating a token sequence (e.g., as an input token sequence or output token sequence). For example, the set of possible tokens for an English language domain may include tokens occurring at least a threshold number of instances in content associated with the English language in a content repository, from an English language dictionary, grammatical marks and other markup used in English texts, and so forth.

The input and output domains may be the same language in some embodiments (i.e., the possible input tokens and output tokens may belong to the same token set); for example, both domains may represent input and output in the same language. This may be used, for example, to generate sequential output content based on an input, such that the transformer model 130 is trained to produce output tokens that represent a desired sequence of tokens to be generated after receiving the input tokens. As one application of this example, the input token sequence may be a first portion of text, such as a sentence or group of sentences, and the transformer model 130 may learn to generate an output token sequence corresponding to a second portion of text that follows the first portion, such as an answer (as an output token sequence) to follow a question (as an input token sequence), or a summary (as an output token sequence) of a document (as an input token sequence).

As such, while the transformer model 130 is generally described herein as relating to language translation of text from one language to another, embodiments of the transformer model 130 may include other types of sequenced input and output that may be characterized with tokens in respective input and output domains.

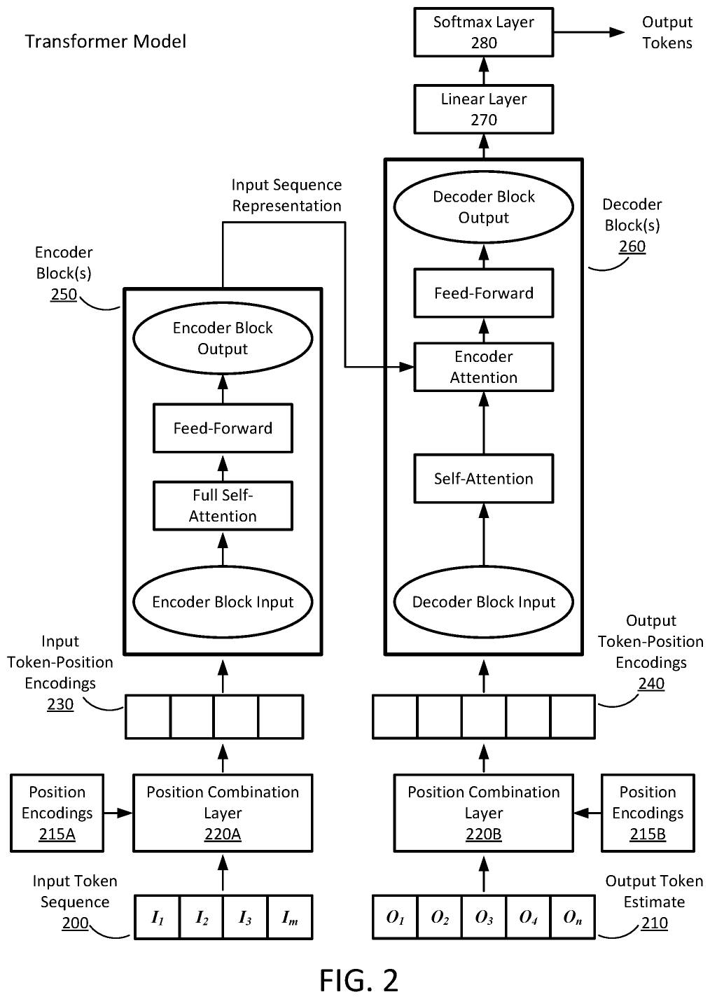

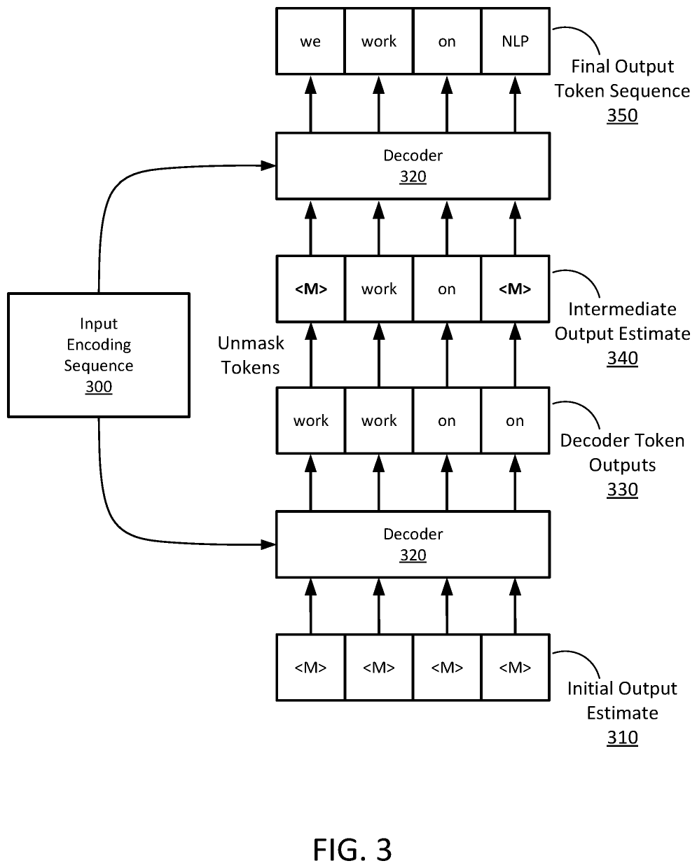

In operation, transformer model 130 processes the sequence of input tokens into an input sequence representation by applying an encoder to the sequence of input tokens. The input sequence representation is then processed by a decoder to generate the sequence of output tokens. The transformer model 130 generally applies a “non-autoregressive” (NAR) approach to decoding, such that more than one output token is predicted in parallel, rather than strictly conditioning a particular output token on the previously-predicted tokens for the output sequence. To do so, the decoder portion of the transformer model 130 incorporates positional information in the representation of a particular output token being predicted and may include attention layers for the decoder that includes a self-attention layer and a masked self-attention layer with respect to an estimated output sequence. As discussed with respect to FIG. 3, the decoder may be iteratively applied, such that one “variable” received by the decoder to be processed for determining an output token sequence may be an output token estimate (e.g., from a previous iteration of the model or from an initialized value). The decoder attention layers may be used to improve the generation and accurate sequencing of output tokens given the parallel generation of output tokens in a given iteration. The architecture of the transformer model 130 is further discussed with respect to FIG. 2.

A model training module 120 may use training data 140 for training of parameters and other configuration settings of the transformer model 130. The training data 140 may include corresponding input-output pairs of a sequence of input tokens and the corresponding sequence of output tokens. The sequence of input tokens may be represented as X={x₁, x₂, . . . , xₘ}, and the output tokens as Y={y₁, y₂, . . . , yₙ}, such that the training data provides a sequence of input tokens X and the corresponding sequence of output tokens Y that should be generated by the model when the model receives input tokens X. As indicated above, the number of input and output tokens in a given pair may differ. For example, a sentence in one language may be represented in fewer words (or more precisely, tokens) than the equivalent sentence in another language.

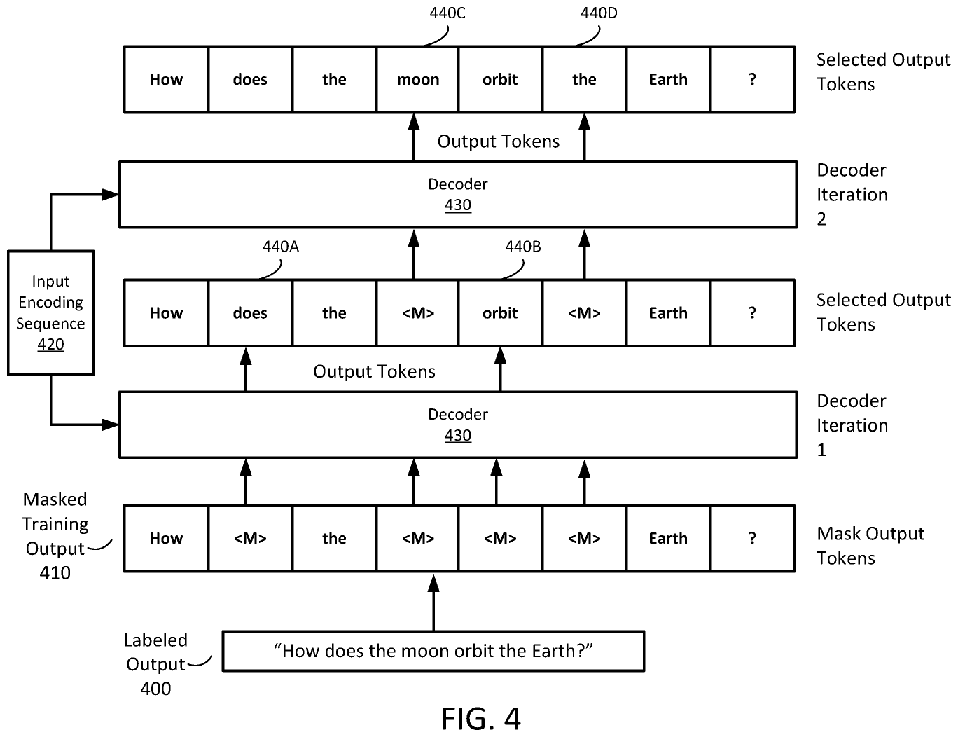

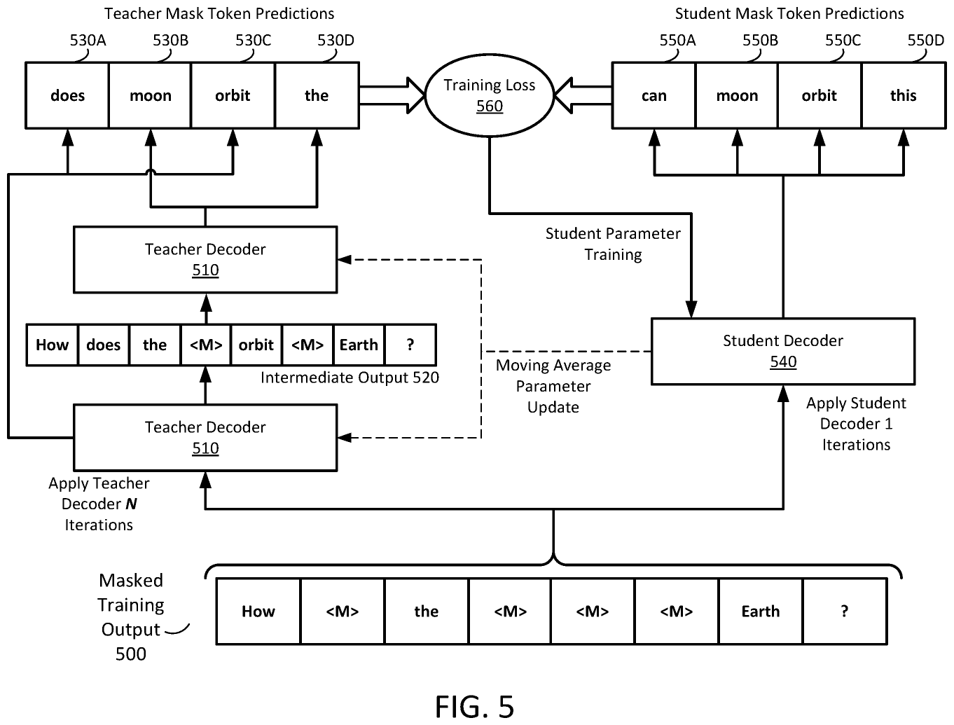

The training data 140 may thus represent a set of “correct” data, such that given a particular training input token sequence of the training data 140, a model training module 120 trains parameters of the transformer model 130 towards predicting the corresponding output token sequence of the training input token sequence. The model training module 120 may train parameters of the model based on a training loss that parameterizes the prediction error of the model and may use backpropagation, gradient descent (or its variants) and other training techniques for modifying model parameters to reduce the training loss. In addition, the model training module 120 may initially train a transformer model to effectively predict the training data 140 with a number of iterative applications of the decoder. The model training module 120 may then use a teacher-student distillation process to teach a student model to learn parameters of the decoder that reduce the required number of iterations for effectively generating the output token sequence. After teacher-student distillation, the student model may then be set as the transformer model 130 for further use. Further details of embodiments of the training process and a training loss are discussed with respect to FIG. 4-5.

Finally, the client request module 110 may apply the trained transformer model 130 to received requests and provide the output to requestors. For example, the client request module 110 may receive an input sequence of tokens (e.g., a German sentence), apply the input sequence of tokens to a transformer model 130 for German to English translation, and provide the output sequence of tokens to the requestor.

The translation system 100 is shown in relation to the components particularly related to the improved operation and training of the transformer model 130 as further discussed below. As such, the particular environment in which the translation system 100 operates may differ in various embodiments, as the translation system 100 may be operated on a server that receives requests from remote computing systems for application of requests to the transformer model 130. In other embodiments, the transformer model 130 may be trained by one computing system and deployed to another computing system for application (e.g., download by a mobile device for operation of the trained transformer model 130). As such, the translation system 100 is any suitable computing system, and the components disclosed below may be separated or combined appropriately across different computing systems for operation. For example, training of the transformer model 130 may also be executed by a plurality of systems in parallel that may share information about modifying model parameters during training. Similarly, further components and features of systems that may include the translation system 100 itself and systems that may include components of the translation system 100 may vary and include more or fewer components than those explicitly discussed herein.

FIG. 2 shows an example architecture of a transformer model, according to one or more embodiments. In general, the transformer model architecture includes two main components: an encoder portion and a decoder portion. The encoder portion represents the portion of the transformer model that converts the input token sequence to an input sequence representation, and the decoder portion represents the portion of the transformer model that processes the input sequence representation to generate an output token sequence.

The encoder portion may begin with an input token sequence 200 in the input domain. The input token sequence 200 includes a number of input tokens of the input domain, which represent individual sequence-able components that may differ according to the particular domain. In the example above, the German language sentence “wir arbeiten an NLP” is represented as four input tokens, each corresponding to one of the four words in this sentence. Each token in the input domain (e.g., each individual word) and output domain are represented by trained multi-dimensional embeddings of an embedding dictionary. The embeddings may be pre-trained by another model that trains the embeddings (e.g., for a particular domain) to infer relational and semantic meaning from the occurrence of the tokens, e.g., based on the respective appearance of the tokens relative to one another in a sequence. The respective token embeddings may thus be determined by any suitable means. The dimensionality of the embeddings may depend on the particular embeddings used for representing the tokens and may also align with the dimensionality of the layers of the transformer model. The embeddings may thus provide a numerical representation of the tokens with respect to a multi-dimensional latent space, such that the “position” of each token typically occupies a unique “position” in the latent space. In one embodiment, the embeddings are in a 512-dimensional latent space; in other embodiments, the latent space may have a different number of dimensions. Hence, each input token of the input token sequence 200 may be converted to its respective embedding (to numerically represent the token) before input to a position combination layer 220A.

In general, the input token embedding itself may not provide positional information of the token with respect to others in the sequence, such that an additional position encoding 215A may be combined with the input embedding in the generation of the input sequence representation. As the input token sequence 200 may vary in length, the positional information may provide both absolute and relative positional information for the respective tokens. However, prior approaches for including positional encodings with the tokens may make it difficult to distinguish between individual tokens, and the representation of adjacent tokens may insufficiently differ during application. To improve the positional information incorporated with the input token embeddings to represent the input token sequence, the position encodings 215A are combined with the input token sequence 200 via a position combination layer 220A.

The position encodings 215A may be the same length as the embedding for an input token, and the position encodings 215A may be a trained value for a particular position or may be a result of a static function. As such, the position encoding may encode information for a particular token position both relatively and with respect to the total length of the input token sequence. That is, the position encoding may be a function of the relative position and the total length of the sequence (e.g., in a 10-token sequence, the position encoding for the second token may be determined based on a function PositionEncode(2, 10)). In one embodiment, the position encoding is based on sine/cosine function that may varyvalues in the encoding representation with a length of the function based on the length of the input token sequence and the sampled point in the sine/cosine function based on the relative position of the input token in the sequence.

In some embodiments, the input token and input position encoding are summed or otherwise combined with a defined function for input to a first encoder block 250. In further embodiments, the combination of input tokens and position encodings is determined with a position combination layer 220A that combines the input token sequence 200 with the position encoding 215A based on a trained computer model layer that may combine the respective values of each input token embedding and the respective position encoding. The combination of each input token embedding with the respective position encoding 215A results in a set of input token-position encodings 230, which may have one input token-position encoding for each input token. In one embodiment, as the input token embedding and position encoding 215A have the same dimensionality (e.g., 512×2), in this embodiment the position combination layer 220A outputs an input token-position encoding 230 that has the same dimensionality as the input token embedding. In one embodiment, the position combination layer 220 is a position-wise layer between the input token embedding and the position encoding 215A. In one embodiment, the position combination layer 220A is a feed-forward network (“FFN”) that receives an input token embedding and a position encoding and outputs an input token-position encoding for that input token at that position. The parameters of the position combination layer 220A may be learned during training of the encoder.

To process the input token-position encodings 230 to the input sequence representation, one or more encoder blocks 250 may be sequentially applied to the input token-position encodings 230. Each encoder block 250 has a respective encoder block input and encoder block output, representing the inputs and outputs respectively of the encoder block 250. In one embodiment, six encoder blocks 250 are used in the encoder. In the first encoder block 250, the encoder block input is the set of input token-position encodings 230. Each encoder block output may be used as the encoder block input for the subsequent encoder block 250, with the encoder block output of the final encoder block 250 used as the input sequence representation. As such, the encoder block input and encoder block output may be a sequence of representations that may correspond to the length of the input token sequence 200. Each representation may have the same dimensionality as an input token embedding, such that the encoding blocks 250 may modify the particular values at a given position but may generally preserve the length of the input token sequence 200.

The encoder block 250 may have various layers having parameters that may be modified during training for processing the encoder block input to generate a respective encoder block output. In this example, the encoder block 250 includes a full self-attention layer and a feed-forward layer, although other embodiments may include additional or different encoder layers than those shown here. After each layer, an add-and-norm layer may be included to combine the layer input with the layer output and normalize them, which may improve model training and regularization.

The full self-attention layer provides an attention mechanism for the encoder block input (in the first layer, to the input token-position encodings 230) by projecting the encoder block input to key, value, and query matrices. The parameters for the projection may be learned during training. The respective query values for a particular position in the encoder block input may be applied to the key matrix to determine weights for combining values from the value matrix. The full self-attention layer may be implemented in various types of attention mechanisms, and may include multi-headed attention (in which multiple key, query, and value projections are calculated and combined) or a dot-product attention layer. The full self-attention layer may also include a softmax layer or other normalization layer to smooth the attention based on the variable input length/length of the key/value projections based on the input token sequence 200.

As noted above, the full self-attention layer may be followed by an add-and-norm layer before the feed-forward layer. The feed-forward layer in one embodiment applies linear transformations with a linear rectification. The feed-forward layer may thus learn further parameters for a position-wise feed-forward layer of the values for each position in an input sequence, in one embodiment, without modifying the dimensionality of the position. For example, the feed-forward layer in one embodiment receives 512 values (i.e., one for each of the 512 dimensions) and applies the feed-forward layer to yield a similar output of 512 values. The resulting output from the feed-forward layer in one embodiment is followed by an add-and-norm layer, the output of which may become the encoder block output for the encoder block 250. The encoder block output of each encoder block 250 may be fed to the next encoder block 250 as the encoder block input, and for the final encoder block 250 may become the input sequence representation to be used for decoding by the decoder.

The decoder receives the input sequence representation and uses it in the generation of the sequence of output tokens. The decoder may begin with a sequence of output tokens as an output token estimate 210. The output token estimate 210 is a sequence of output tokens that may represent an “estimate” of the output tokens to be refined by application of the decoder. In one embodiment, the decoder attempts to decode the entire sequence of output tokens simultaneously.

FIG. 3 shows an example of an iterative application of a decoder, according to one or more embodiments. The example of FIG. 3 may show an example of the decoder applied during inference in which, initially, the decoder has no prediction for the output tokens. To seed the decoder, the decoder may operate on an initial output estimate 310, in which each position in the output estimate is populated with a value for a “mask” token, designated in FIG. 3 as <M>. The mask token may also be used to designate positions for which the model is applied to predict output tokens. During training of the decoder, portions of a labeled output (e.g., of an input-output sequence pair in the training data) are replaced with the mask token to learn parameters for the decoder to interpret output estimates that include mask tokens. The decoder 320 may receive the output estimate (here, initial output estimate 310) and generate a set of output tokens as the predicted tokens for the output sequence.

To iteratively apply the model, the output of one iteration is used to determine an output estimate received by the next iteration. Here, the output of the first iteration of the decoder 320 is labeled as decoder token outputs 330. As discussed below, the decoder applied to each position of the output sequence may determine a distribution of relative likelihood or otherwise score the output tokens. That is, at each position, the decoder may predict relative scores, probabilities, or confidences for a set of candidate output tokens, which may generally be referred to as a token distribution for the position (which generally refers to the distribution of token scoring and may or may not reflect a probabilistic distribution). The highest-likelihood (e.g., highest-scoring) token for each position is shown as decoder token outputs 330. Although the decoder 320 may generate tokens and related scores for each position, across the output sequence, the decoder token outputs 330 may repeat tokens or may otherwise have different confidence levels (e.g., as reflected in token scores/distributions) across the positions of the output sequence as shown by the repeated tokens in this example.

As such, in one embodiment at each iteration, a number of token outputs of the model may be selected to replace or “unmask” the mask tokens evaluated at that iteration. The number of tokens that are unmasked at each iteration may be a specific value or portion of the output sequence (e.g., a specific percentage or 1/N of the positions for a decoder trained to be applied for N iterations). The particular tokens unmasked may be based on the token distribution or value of the highest-scoring token in the token distribution for each position. As one example, the maximum value in the token distribution for each position may be ranked to determine the positions having the highest confidence in predicting a particular output token.

A number of positions having the highest-scoring tokens are selected to be replaced with the respective token predictions. In further embodiments, a number of tokens to unmask may vary in different iterations, for example based on the token distributions or relative token likelihoods. For example, when the token distributions for several positions are relatively confident (e.g., the prediction for a specific token for a specific position is above a relative confidence level or score), additional tokens may be unmasked in an iteration; when relatively fewer less token distributions are relatively confident, fewer tokens may be unmasked in an iteration.

In this example, two tokens are selected to be unmasked corresponding to the second and third positions in the output sequence, such that the mask tokens of the output estimate received by the decoder 320 are replaced by the decoder token outputs 330 to generate an intermediate output estimate 340. A next iteration of applying the decoder 320 receives the intermediate output estimate 340 to unmask further tokens, which in this example are the remaining tokens and generate a final output token sequence 350.

In this example, two iterations of applying the decoder 320 are used for a short sentence; in other examples, the decoder 320 may be applied several times to generate a final output token sequence 350. As such, where an input encoding sequence 300 may remain constant, the decoder 320 may iteratively determine output tokens over repeated iterations. In this example, the mask tokens are replaced at each application of the decoder 320; in other examples, the intermediate output estimate 340 may be set to the decoder token outputs 330, such that the “best guess” of an output token for each position is provided to the subsequent decoder iteration, rather than replacing the masked token for specific positions.

As the several output tokens may be translated in parallel across a single application of the decoder 320 (e.g., as shown between the initial output estimate 310 and the decoder token outputs 330), output tokens may tend to err in sequentially producing the same token (here, illustrated in the repetition of “work” and “on” in the decoder token outputs 330) or in predicting relatively low confidence for tokens at particular positions. In some embodiments, the decoder may be applied for a specified number of iterations, such as five or ten, or may be adaptively applied based on the predicted confidence of tokens or the change in confidence or tokens across iterations. In some embodiments, an output estimate may have a portion of tokens between iterations (e.g., a portion having the lowest confidence) replaced with (or maintain) the mask token, such that the decoder 320 may emphasize revisions to the output estimate for positions having the mask token.

As such, for each iteration of the decoder 320, the decoder 320 may be applied to each position having a mask token to determine output token distributions and select which mask tokens to replace based on the decoder's predicted output token. Stated another way, at each iteration, a number of tokens may be “unmasked” based on the decoder's output token predictions, while other tokens remain masked for further decoder iterations, such that the output estimate is “unmasked” over iterative applications of the decoder 320. In the example of FIG. 3, two tokens are selected at each iteration, such that the intermediate output estimate 340 has two masked tokens of the initial output estimate 310 replaced with the highest-scoring output tokens.

Returning to FIG. 2, to iteratively apply the decoder 320 as shown in FIG. 3, an output token estimate 210 may be the output token sequence from a prior iteration of the decoder or may be a set of initialized values, such as an all-masked sequence, for a first iteration of the decoder 320. As with the input tokens, the output tokens from the output token estimate 210 may be converted to respective output token embeddings and combined with position encodings 215B with a defined function (e.g., a sum or other combination) or with a position combination layer 220B to generate output token-position encodings 240. The parameters of the position combination layer 220B and position encodings 215B may also be learned parameters during training and may differ from the parameters of the position encodings 215A and position combination layer 220A; in other embodiments, the parameters for the position combination layer 220B and position encodings 215B may be shared between the encoder and decoder.

As shown in FIG. 2, the output token estimate 2102 may be a different length than the input token sequence 200. As several output tokens may be simultaneously generated, it may not be effective for the decoder to output a discrete “end-of-sequence” token. As such, in some embodiments, the length of the output token sequence (and correspondingly, the output token estimate) may be estimated during the input encoding, such that the encoder includes a layer that may generate a length estimate for the output token sequence and include the length estimate with the input sequence representation. In some embodiments, the length of the output token estimate 210 may be set to the generated length estimate. In other embodiments, multiple output sequences may be generated for each of several output lengths, such that the output token sequence used as the final decoder output may be selected based on the output token probabilities. In one embodiment, the length estimate and/or the several output lengths may be generated based on a trained layer that uses the length of the input sequence, the tokens of the input sequence, and/or the input sequence representation.

Similar to the encoder structure, the decoder 320 may also include a set of one or more decoder blocks 260 that may be sequentially applied, such that a first decoder block 260 may receive the output token-position encodings 240 as a decoder block input, and output its decoder block output to become the decoder block input for the next decoder block 260. The decoder block output of the last decoder block 260 may then be processed to determine the output token sequence. In one embodiment, the decoder includes six decoder blocks. As with the encoder blocks 250, the decoder block input and decoder block outputs may also be sequenced representations that have an associated length that may generally correspond to the length of the output token estimate 2102 (and may be, e.g., the number of tokens being translated in parallel at once). Similar to the encoder block 250, as discussed above, between each layer of the decoder block 260 may be an add-and-norm layer for combining the input of the previous layer in the decoder block 260 with the output of the current layer and normalizing them.

The layers of each decoder block 260 may include components for processing the decoder block input to determine how to process the input sequence representation for each output position. More particularly, the decoder block input may be used to generate values for an attention mechanism with respect to the input sequence representation.

As shown in the example embodiment of FIG. 2, the decoder block 260 includes a self-attention layer, which may include a full self-attention layer and/or a masked self-attention layer in varying embodiments. In some embodiments, a combination of full self-attention and masked self-attention enables the decoder block 260 to both attend to the entire sequence of information in the decoder block input, while also encouraging sequenced (e.g., left to right) attention. A full self-attention layer in the decoder block 260 may operate similarly to the full self-attention layer in the encoder block 250, such that the decoder block input is projected to key, value, and query values based on learned parameters, that together may form key, value, and query matrices for attending to different portions of the decoder block input. A masked self-attention layer operates similarly to the full self-attention layer, except that the masked self-attention layer provides ordering to the decoder block inputs, such that a particular position in the decoder block input may only attend to (i.e., be affected by) the values from the prior positions in the sequence of decoder block inputs. In one implementation, this may be performed by setting the contribution of the subsequent tokens to zero when combining the respective values of the later tokens from the value matrix.

After the self-attention layer(s), the resulting information may conceptually describe information currently predicted/known about each output position in the context of the other output positions. The result of this decoder self-attention is then used to determine values for the output positions based on the input sequence representation. That is, the information from the output estimate is used to weight and select values from the input sequence representation. In one embodiment, the encoder attention layer forms key and value matrices from the input sequence representation, and a query matrix from the output attention layer(s) (here, the full self-attention and masked self-attention layers). As such, the query values (which may have the output token length) may be used to control attention for the key and value matrices representing the input sequence representation.

The result from the encoder attention layer may then be input to a feed-forward layer that may operate similarly to the feed-forward layer in the encoder as discussed above and provide a fully-connected layer position-wise for the output sequence. In the decoder block 260 shown in FIG. 2, at the output of each layer, the representation of the output sequence may continue to maintain the same dimensionality (e.g., 512). As noted above, several decoder blocks 260 may be applied in sequence with individual parameters for each decoder block determined during training.

After the final decoder block 260, the result may be provided to a linear layer 270 that may provide a fully-connected layer for each position to output tokens for each position, after which a softmax layer 280 may convert the resulting values to probabilities of each associated output token. In one embodiment, the linear layer 270 operates as a classifier, such that each output token represents a particular output class. As such, the linear layer 270 may convert the output of the decoder blocks 260 to a likelihood of each respective output token, which is normalized via the softmax layer 280. The output of the softmax layer 280 may then be used as the token distributions from which the highest-predicted token may be selected as the respective decoder output token for each position for a particular iteration of the decoder.

FIG. 4 shows an example of training data flow for reducing decoder iterations, according to one or more embodiments. As discussed above, to improve performance of the non-autoregressive decoder (e.g., predicting the output tokens for each masked position in parallel), the decoder 430 may be applied in several iterations. For example, complex input sequences may correspond to a relatively high length of the corresponding output token sequence. For complex sentences, paragraphs, or pages of textual output, this may represent dozens or hundreds of output tokens. To perform well in predicting these output lengths, the decoder 430 may be trained for iterative application of 5, 10, 20 or more iterations. An initial transformer model 130 may be trained based on the training data 140 to effectively predict output token sequences by unmasking tokens across a plurality of iterations. This transformer model 130 may be trained to apply a decoder model in a number of iterations to generate effective output tokens based on the training data 140 of input token sequence and output token sequence pairs (e.g., a pair (x, y) of input token sequence x and output token sequence y). The transformer model 130 may be trained with any suitable method, such as by masking (partially or completely) the output token sequence y and training parameters of the transformer model 130 to predict output tokens iteratively, e.g., with a cross-entropy or other loss function.

To further improve this decoder, the model training module 120 may further refine the transformer model 130 to reduce the number of iterations required for a decoder to be applied to generate effective output token sequences with similar accuracy. A “student” model may thus be trained to learn parameters for fewer iterations that mimic the performance of multiple applications of a “teacher” model. This process may generally be referred to as teacher-student distillation. The student model may then be used to generate output tokens with a reduced number of iterations, distilling multiple iterations of the teacher model to a reduced number of iterations for the student model. In some embodiments, the teacher model and student model may have the same model architecture, such as the architecture discussed with respect to FIG. 2. Alternative model architectures for non-autoregressive decoder models may also be used in various embodiments. As discussed further below, the same model architecture for the teacher model and student model may also permit the teacher model to be updated during training, such that further refinement to the per-iteration performance may be learned with further training.

Initially, parameters of the teacher model and student model may be set to the values of a transformer model 130 trained on the training data 140. The teacher-student distillation may be performed for a variety of non-autoregressive decoder approaches to reduce the number of iterations for an iteratively-applied decoder, including the architectures discussed above as well as alternate model architectures that may differ, e.g., from FIG. 2. As such, in one embodiment, the teacher-student distillation may be applied to a trained transformer model, such that embodiments of the teacher-student distillation include a pre-trained transformer as well as training a transformer model 130 for which to apply the teacher-student distillation. The transformer model parameters before application of the teacher-student distillation may be referred to as a “base transformer model.”

To train the student model, the teacher model is applied a number of iterations to a masked training output 410 to generate output tokens for the masked tokens according to the teacher model. As the transformer models may have already been trained on the labeled inputs and outputs of the training data, the training process may particularly focus on decoder iterations in which the outputs are partially masked, rather than the initial output estimate 310 shown in FIG. 3, in which the entire output sequence is set to mask tokens. As such, the number of iterations that the teacher model is applied for the teacher-student distillation may be less than all of the iterations used in normal application of the teacher model. For example, where the base transformer model is trained to be applied in ten iterations, with each iteration unmasking 1/10th of the output sequence tokens, during teacher-student distillation the teacher model may be applied two times to teach the student model to mimic two iterations of the teacher model in one iteration of the student model.

As training data for the teacher model and student model, an input token sequence and output token sequence is retrieved for a training pair of training data 140. FIG. 4 illustrates applying two iterations of the teacher model to generate an unmasked output token sequence. In this example, the training data output token sequence is shown as a labeled output 400 for the token sequence “How does the moon orbit the Earth?” The labeled output 400 is then at least partially masked to generate a masked training output 410. In one embodiment, rather than masking all positions of the labeled output sentence, a number of tokens are masked corresponding to the number of iterations for which the teach model will be applied. For example, in an unmasking policy in which tokens are unmasked linearly (i.e., each iteration unmasks a percentage 1/N for a base transformer using N decoder iterations), the masked training output 410 includes a number of mask tokens proportional to the number of iterations for the teacher model. In this example, the student model is trained to learn parameters for two iterations of the teacher model that, for this sequence length, unmasks two tokens in each iteration. As such, the masked training output 410 in this example masks four tokens. The particular tokens to mask may be determined randomly, or may be determined by applying the teacher model for an initial number of iterations, such as a number of its normal iterations minus the number to be used for training (e.g., here, four iterations may typically be performed in the base transformer model and reduced by two for the two iterations to be learned by the student model).

The teacher model's encoder may then be applied to generate an input encoding sequence 420 for the teacher model, and the decoder 430 is iteratively applied, selecting tokens 440A-D as the output tokens for the teacher model. The output tokens may be selected at different iterations; in this example, output tokens 440A, 440B are selected in the first iteration, and output tokens 440C, 440D are selected in the second iteration. As discussed further in FIG. the token distributions may also be stored for each selected token, indicating the distribution of tokens at the iteration in which the teacher model selected the output token. The output tokens 440A, 440B may thus have respective token distributions based on the output of the first decoder iteration, while output tokens 440C, 440D may have respective token distributions. As such, the teacher model may be applied multiple iterations to the masked training output 410 to determine the selected output tokens from which the student model may learn. In addition, when the masked training output 410 is partially masked, in addition to reducing the number of iterations for the student model, this may also focus the student model on improving efficacy of token prediction when the model has a partially-generated output sequence. This may focus improvements of the student model on later iterations of the teacher model, with a reduced risk of affecting token prediction of the initial all-masked token sequence.

FIG. 5 shows an example data flow for teacher-student distillation of iterative decoding, according to one or more embodiments. FIG. 5 continues the example of FIG. 4 in which the teacher model is applied twice (i.e., two iterations), with equivalent results to be learned by the student model in one iteration. As noted above, the student model and teacher model may have the same architectures and may initially be set to parameters of a transformer model having a non-autoregressive decoder to be iteratively applied during inference. Although two iterations of a teacher decoder 510 and one of a student decoder 540 are shown in FIG. 5, in other embodiments, additional iterations of each may be used to adjust the ratio of teacher iterations learned by the student.

As discussed in FIG. 4, a masked training output 500 may be identified (or generated) from a training input and output. The masked training output 500 may then be processed by the teacher decoder 510 of the teacher model and the student decoder 540 of the student model to generate respective teacher mask token predictions 530A-D and student mask token predictions 550A-D with the designated number of iterations for the teacher model and the student model. Although not shown in FIG. 5, the teacher model and student model also each include an encoder as discussed above (e.g., with respect to FIG. 2), that generates an input sequence representation from the input sequence corresponding to the output sequence of the masked training output 500. That is, for a training input-output sequence pair, the input sequence is processed by the respective encoders to the respective input sequence representations, and the training output sequence may be masked to generate the masked training output 500. In some embodiments, the encoder model parameters are fixed for the teacher-student distillation, such that the same input sequence representation may be used for the teacher decoder 510 and the student decoder 540; in other embodiments, the encoder model parameters may also be modified during the teacher-student distillation, such that different input sequence representations may be generated for the teacher models and student models.

In this example, the teacher model is applied for two iterations, such that between the first and second iteration, an intermediate output 520 is generated as discussed with respect to FIGS. 3 and 4 for input to the second iteration of the teacher decoder 510. As shown in FIG. 5, the individual teacher mask token predictions 530A-D may be obtained at different iterations of the teacher decoder 510. In this example, the teacher mask token predictions 530A, 530C are generated in the first iteration, and the teacher mask token predictions 530B, 530D are generated in the second iteration. The teacher mask token predictions 530A-D may include sufficient information for evaluation of a training loss 560 with respect to the student mask token predictions 550A-D. This may include additional information beyond the particular output tokens that the teacher decoder 510 selected and reveal intermediate values of the teacher decoder for the position of the respective teacher mask token predictions 530 when the teacher token was selected. As such, at each iteration, when a token is selected as an output for the teacher decoder, data for the teacher model evaluation of that position is captured for the loss evaluation.

For each selected token, the relevant additional information for that position may also be captured and stored for evaluation of the loss that may represent “soft labels” for the student model to learn. The additional information may depend on the particular architecture of the models and may include the token distribution and one or more hidden layer output values of the teacher decoder 510. For an architecture shown in FIG. 2, for example, the token distribution may be the output of the softmax layer 280 and the hidden layer output values may be the output of the linear layer 270 or the feed-forward layer of the final decoder block 260. This additional data provides further information describing teacher model's “reasoning” for its selection of particular output values, enabling the student model to learn parameters that incorporate more nuanced information about how the teacher model represents the likelihoods of the possible output tokens.

The student decoder 540 is similarly applied to the masked training output 500 to generate student mask token predictions 550A-D for generation of a training loss 560 used to train the student model parameters. The training loss 560 is defined by a loss function that encourages the student mask token predictions 550A-D for each position to match the teacher mask token predictions 530A-D. That is, student mask token prediction 550A is evaluated with respect to teacher mask token prediction 530A, student mask token prediction 550B is evaluated with respect to teacher mask token prediction 530B, and so forth. In some embodiments, rather than directly evaluating whether the output tokens are the same, the loss function may also include terms encouraging the student model to generate a similar token distribution (which includes encouraging the student model to have the same highest-scored output token) and/or hidden layer values (i.e., hidden states) as the teacher model outputs. As such, the loss function may encourage the student model to learn parameters that learn to combine the iterations of the teacher model into fewer iterations.

In one embodiment, the student model may be trained with a loss function including a KL-divergence of the token distribution for a position (e.g., a KL-divergence of the token distribution for teacher mask token prediction 530A with respect to student mask token prediction 550A). In addition, the hidden layer values may be evaluated in one embodiment as a Euclidian distance, such that the loss function aims to minimize the Euclidian distance between the respective teacher and student hidden states. In one embodiment, the loss function for the teacher-student distillation includes a KL-divergence between the token distributions evaluated for each masked position and includes a hidden state loss, and is defined as:

$$ℒ ← {\sum }_{i} K L ( {p}_{t , i} \vert {p}_{s , i} ) + λ {‖ {e}_{t , i} - {e}_{s , i} ‖}^{2} \qquad Equation 1$$

in which [symbol] is the loss function across masked positions i in the masked training output,
P_{t,i} is the token distribution of the teacher model for position i,
P_{s,i} is the token distribution of the student model for position i,
e_{t,i} is the teacher model hidden state for position i,
e_{s,i} is the student model hidden state for position i, and
λ is a hyper-parameter that controls the contribution of hidden state loss.

The training loss may be evaluated for a number of training data samples and may then be applied to update parameters of the student model with a suitable parameter update algorithm, such as via gradient descent. In one embodiment, the parameters of the student decoder 540 are updated and the encoder portion of the student model remains fixed. In another embodiment, the training includes modifying parameters of the encoder model as well as the student decoder 540.

After training the student decoder, e.g., with a number of training items, batches, or to convergence, the training process may be modified to further improve the performance of the student decoder 540. In one embodiment, the number of iterations of the teacher model 510 may be increased, for example, from two to three or three to four iterations. As another example, the student decoder 540 may then operate as a teacher decoder 510 for further refinement of the student decoder 540. That is, the parameters of the “teacher model” may be replaced by the parameters of the student model. As one example, a first student model may learn from two iterations of a teacher decoder (as one iteration of the first student model), and then a second student model may further learn from two iterations of the first student model (as one iteration of the second student model).

In a further example, rather replace the teacher model, as the student decoder 540 may represent an improved capability to more accurately predict output tokens in fewer iterations, the parameters of the student model may be blended with parameters of the teacher model, such that the parameters of the teacher model move towards the improvements of the student model without being replaced. This may be performed by updating the teacher model parameters as a moving average, such as an exponential moving average, with respect to the trained student model parameters. In one embodiment, the modified teacher parameters may be updated with a weighted contribution of the prior teacher model parameters and the student model parameters. In some embodiments, the teacher model is updated relatively slowly, such that the weight of the prior teacher model parameters may be 0.9, 0.99, or 0.999 of the updated teacher model parameters. This high contribution for the prior teacher model may prevent the contribution of the student decoder from too quickly modifying the teacher model parameters and destabilizing the model predictions. However, by including updates to the teacher model parameters during training, additional improvements to the student model can be achieved as the teacher model also improves its performance.

After teacher-student distillation, the student model may then be applied with a reduced number of iterations relative to the base transformer model to generate a substantially equivalent output token sequence. The reduction in the number of iterations for applying the student model in inference may be proportional to the ratio of teacher model to student model iterations in training (here, 2:1, such that 10 iterations of the teacher model may be reduced to 5 iterations of the student model) or may be a lower ratio. The reduced number of iterations that a student model is applied for inference of new input token sequences (i.e., a completely masked output estimate) may differ from the ratio of teacher model iterations to student model iteration(s) during the teacher-student distillation (in the examples here, two teacher model iterations relative to one student model iteration).

As such, the teacher-student distillation reduces the number of decoding steps without degrading transformer performance and enabling significant improvement in execution time.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A system comprising:
one or more processors; and
one or more non-transitory computer-readable media having instructions executable by the one or more processors for:
identifying a masked training output having two or more masked positions of a labeled output token sequence comprising a plurality of positions having respective output tokens and an associated input token sequence;
determining a set of teacher mask token predictions for the masked positions by iteratively applying a non-autoregressive teacher model for a plurality of sequential iterations to the masked training output and the input token sequence, the set of teacher mask token predictions including teacher mask token predictions determined at different iterations in the plurality of sequential iterations;
determining a set of student mask token predictions for the masked positions by applying a non-autoregressive student model to the masked training output and the input token sequence associated with the labeled output token sequence;
determining a training loss based on the set of teacher mask token predictions compared to the set of student mask token predictions; and
updating parameters of the student model based on the training loss.

2. The system of claim 1, wherein the teacher mask token predictions and student mask token predictions are score distributions of output tokens and the training loss is a comparison of the score distributions for each masked token.

3. The system of claim 2, wherein the training loss is a KL-divergence of the score distributions of the teacher mask token predictions and the student mask token predictions.

4. The system of claim 1, wherein the masked training output includes unmasked tokens.

5. The system of claim 1, wherein execution of the instructions by the one or more processors is further for updating the teacher model based on the update to the student model.

6. The system of claim 5, wherein updating the teacher model comprises modifying parameters of the teacher model as a moving average with parameters of the student model.

7. The system of claim 5, wherein updating the teacher model comprises replacing parameters of the teacher model with parameters of the student model.

8. The system of claim 1, wherein execution of the instructions by the one or more processors is further for increasing a number of masked positions and a number of the plurality of sequential iterations of the teacher model after updating parameters of the student model.

9. The system of claim 1, wherein execution of the instructions by the one or more processors is further for initializing parameters of the teacher model and the student model to the same values.

10. The system of claim 1, wherein the training loss includes a hidden state loss based on one or more hidden layer values of a hidden layer of the teacher model for each teacher mask token prediction compared to hidden layer values of a hidden layer of the student model for each of the respective student mask token predictions.

11. A method, comprising:
identifying a masked training output having two or more masked positions of a labeled output token sequence comprising a plurality of positions having respective output tokens and an associated input token sequence;
determining a set of teacher mask token predictions for the masked positions by iteratively applying a non-autoregressive teacher model for a plurality of sequential iterations to the masked training output and the input token sequence, the set of teacher mask token predictions including teacher mask token predictions determined at different iterations in the plurality of sequential iterations;
determining a set of student mask token predictions for the masked positions by applying a non-autoregressive student model to the masked training output and the input token sequence associated with the labeled output token sequence;
determining a training loss based on the set of teacher mask token predictions compared to the set of student mask token predictions; and
updating parameters of the student model based on the training loss.

12. The method of claim 11, wherein the teacher mask token predictions and student mask token predictions are score distributions of output tokens and the training loss is a comparison of the score distributions for each masked token.

13. The method of claim 12, wherein the training loss is a KL-divergence of the score distributions of the teacher mask token predictions and the student mask token predictions.

14. The method of claim 11, wherein the masked training output includes unmasked tokens.

15. The method of claim 11, wherein the method further comprises updating the teacher model based on the update to the student model.

16. The method of claim 15, wherein updating the teacher model comprises modifying parameters of the teacher model as a moving average with parameters of the student model.

17. The method of claim 15, wherein updating the teacher model comprises replacing parameters of the teacher model with parameters of the student model.

18. The method of claim 11, wherein the method further comprises increasing a number of masked positions and a number of the plurality of sequential iterations of the teacher model after updating parameters of the student model.

19. The method of claim 11, wherein the method further comprises initializing parameters of the teacher model and the student model to the same values.

20. The method of claim 11, wherein the training loss includes a hidden state loss based on one or more hidden layer values of a hidden layer of the teacher model for each teacher mask token prediction compared to hidden layer values of a hidden layer of the student model for each of the respective student mask token predictions.
